(19) United States
(12) Patent Application Publication
(10) Pub. No.: US 2009/0172768 A1
(43) Pub. Date: Jul. 2, 2009

(54) METHODS AND APPARATUS FOR OPERATING EMBEDDED INFORMATION TECHNOLOGY APPLICATIONS WITH A SERVICE OPERATING SYSTEM

(76) Inventors: Huifeng Le, Shanghai (CN); Adam Wu, Shanghai (CN); Roly Liang, Shanghai (CN); Bin Zhu, Shanghai (CN); Qing Wang, Shanghai (CN)

Correspondence Address: Barnes & Thornburg, LLP, c/o CPA Global, P.O. Box 52050, Minneapolis, MN, 55402, US

(21) Appl. No.: 11/966,290

(22) Filed: Dec. 28, 2007

(51) Int. Cl. G06F 21/00; G06F 9/445

(52) U.S. Cl. 726/1; 718/1

(57) ABSTRACT

A method includes setting a rule policy with an embedded information technology application. The method further includes parsing the policy rule from a policy engine to a context engine. The method further includes determining a computing device condition with the context engine based upon the parsed policy rule. The method further includes notifying the policy engine with the context engine if the computing device condition has changed from a first condition to a second condition. The method further includes, in response to the computing device condition changing from the first condition to the second condition, executing an action according to the parsed policy rule. An associated system and machine readable medium are also disclosed.

### BACKGROUND

Embedded information technology focuses on defining a set of usages aimed at benefiting information technology departments and home personal computer customer support by providing advanced and remote capabilities for various purposes.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 shows a block diagram of an embodiment of a computing device.

FIG. 2 shows a block diagram of an embodiment of a software environment operating on a computing device.

FIG. 3 shows a flowchart of an embodiment of a routine for processing information regarding a computing device.

FIG. 4 shows a block diagram of an embodiment of software implemented to determine the health of a hard disk drive.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; and others.

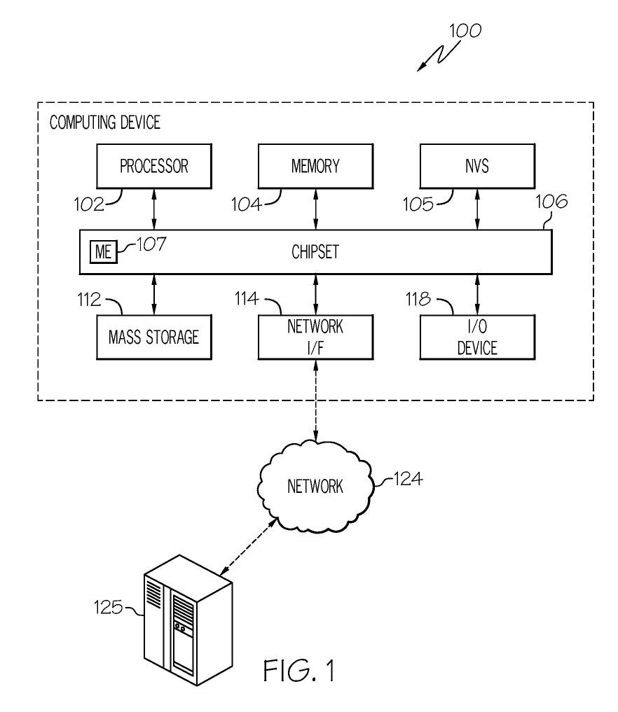

Referring now to FIG. 1, one embodiment of a computing device 100 is shown. The computing device 100 may include a processor 102 and a memory 104 coupled to a chipset 106. A mass storage device 112, a non-volatile storage (NVS) device 105, a network interface (I/F) 114, and an Input/Output (I/O) device 118 may also be coupled to the chipset 106. Embodiments of computing device 100 include, but are not limited to, a desktop computer, a notebook computer, a server, a personal digital assistant, a network workstation, or the like. In one embodiment, the processor 102 may execute instructions stored in memory 104.

The processor 102 may include, but is not limited to, processors manufactured or marketed by Intel Corp., IBM Corp., and Sun Microsystems Inc. In one embodiment, computing device 100 may include multiple processors 102. The processors 102 may also include multiple processing cores. Accordingly, the computing device 100 may include multiple processing cores for executing instructions of the computing device 100.

The memory 104 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like. In one embodiment, the memory 104 may include one or more memory units that do not have to be refreshed.

The chipset 106 may include a memory controller, such as a Memory Controller Hub (MCH), an input/output controller, such as an Input/Output Controller Hub (ICH), or the like. In an alternative embodiment, a memory controller for memory 104 may reside in the same chip as processor 102. In one embodiment, the chipset 106 may include a manageability engine (ME) 107, which may be used to allow remote out-of-band management of the computing device 100. In one embodiment, the manageability engine 107 may be a processor located in the MCH of the chipset 106. The chipset 106 may also include system clock support, power management support, audio support, graphics support, or the like. In one embodiment, chipset 106 is coupled to a board that includes sockets for processor 102 and memory 104.

The components of the computing device 100 may be connected by various interconnects. In one embodiment, an interconnect may be point-to-point between two components, while in other embodiments, an interconnect may connect more than two components. Such interconnects may include a Peripheral Component Interconnect (PCI), such as PCI Express, a System Management bus (SMBUS), a Low Pin Count (LPC) bus, a Serial Peripheral Interface (SPI) bus, an Accelerated Graphics Port (AGP) interface, or the like. I/O device 118 may include a keyboard, a mouse, a display, a printer, a scanner, or the like.

The computing device 100 may interface to external systems through network interface 114. The network interface 114 may include, but is not limited to, a modem, a Network Interface Card (NIC), or other interfaces for coupling a computing device to other computing devices. A carrier wave signal 123 may be received/transmitted by network interface 114. In the embodiment illustrated in FIG. 1, carrier wave signal 123 is used to interface computing device 100 with a network 124, such as a Local Area Network (LAN), a Wide Area Network (WAN), the Internet, or any combination thereof. In one embodiment, network 124 is further coupled to a computing device 125 such that computing device 100 and computing device 125 may communicate over network 124.

The computing device 100 also includes non-volatile storage 105 on which firmware and/or data may be stored. Non-volatile storage devices include, but are not limited to, Read-Only Memory (ROM), Flash memory, Erasable Programmable Read Only Memory (EPROM), Electronically Erasable Programmable Read Only Memory (EEPROM), Non-Volatile Random Access Memory (NVRAM), or the like.

The mass storage 112 may include, but is not limited to, a magnetic disk drive, such as a hard disk drive, a magnetic tape drive, an optical disk drive, or the like. It is appreciated that instructions executable by processor 102 may reside in mass storage 112, memory 104, non-volatile storage 105, or may be transmitted or received via network interface 114.

In one embodiment, the computing device 100 may execute an Operating System (OS). Embodiments of an OS include Microsoft Windows®, the Apple Macintosh operating system, the Linux operating system, the Unix operating system, or the like.

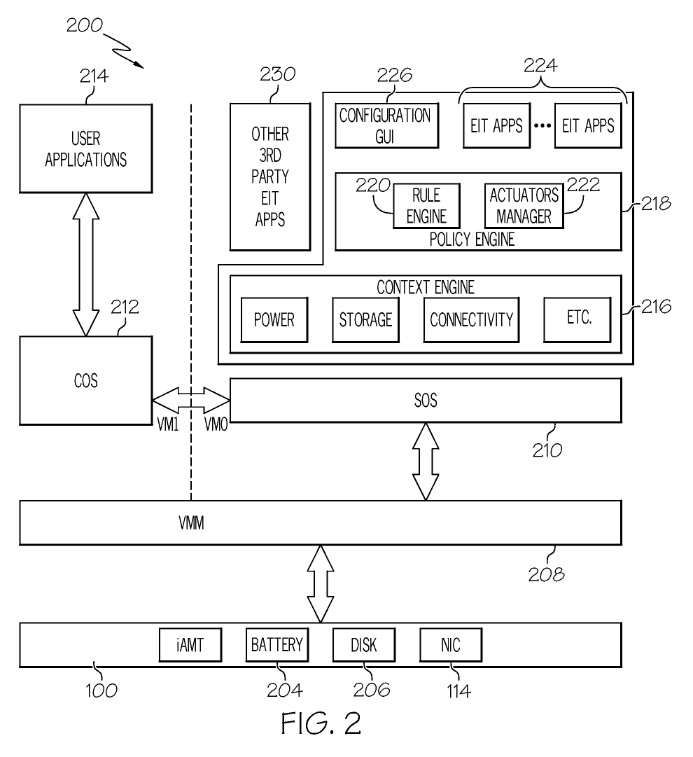

Referring now to FIG. 2, there is shown a block diagram of a software environment 200 that may be operated on the computing device 100. The computing device 100 in the embodiment of FIG. 2 may include a battery 204, hard disk drive 206, and network interface card 114. In one embodiment, the computing device 100 may include an Intel vPro platform, which may implement the Intel Active Management Technology designated as “iAMT” in FIG. 2.

A virtual machine monitor (VMM) 208 may operate on the computing device 100. In one embodiment, the VMM 208 may operate a plurality of virtual machines such as VM0, VM1. The virtual machine VM1 may operate a service operating system (SOS) 210, such as a Windows or Linux based operating system, for example. The virtual machine VM0 may operate a capability operating system (COS) 212, such as Windows XP, for example. The COS 212 may allow various user applications 214 to be executed thereon.

Referring again to the virtual machine VM0, the SOS 210 may operate a context engine software 216, which may be implemented as software, and provide a device information layer, allowing it to provide information in regard to the computing device 100, such as power, disk storage, and connectivity information, for example. The context engine may provide a single application programming interface (API) across a plurality of operating systems and implement multiple languages. During runtime, the context engine 216 may also communicate synchronously or asynchronously. This allows various embedded information technology (EIT) applications to query system context information through a synchronous mode, or subscribe to receive an event notification occurring in the computing device 100 though an asynchronous event mechanism.

A policy engine 218 may be implemented as software operated through the context engine 216. The policy engine 218 may contain rule engine 220 and actuator provider managers 222. The policy engine 218 may load and parse predefined rules using the rule engine 220, analyze system context status or await event notification from the context engine 216. The policy engine 218 may also invoke the actuators managers 222 to select an accurate actuator and execute a rule.

A plurality of EIT applications 224 may be operated through the policy engine 218. In one embodiment, each of the plurality of EIT applications 224 may be used for tasks regarding various aspects of the computing device 100 such as provisioning, manageability, diagnostics, and remediation. A configuration graphical user interface (GUI) 226 may be used by a user as a policy management console, allowing an information technology (IT) administrator to define various rules to be enforced or to add/remove various EIT applications. Other EIT applications 230 may be implemented and configured to operate outside the policy engine 216 and directly on the context engine 218.

During operation of the software environment 200, the plurality of EIT applications 224 may be used to determine various information in regard to the computing device 100. The configuration of FIG. 2 may allow the plurality of EIT applications 224 to be used without the EIT applications being specifically designed for the computing device 200 but coordinated accordingly by the software environment 200. Furthermore, allowing the EIT applications 224 and 230 to run on the SOS 210 and remain protected from any undesirable activities from the COS 212. For example, the embodiment shown in FIG. 2 may protect the SOS 210 from any viruses running on the COS 212 due to the COS 212 being precluded from accessing the SOS 210 due to running on different virtual machines VM1, VM0, respectively.

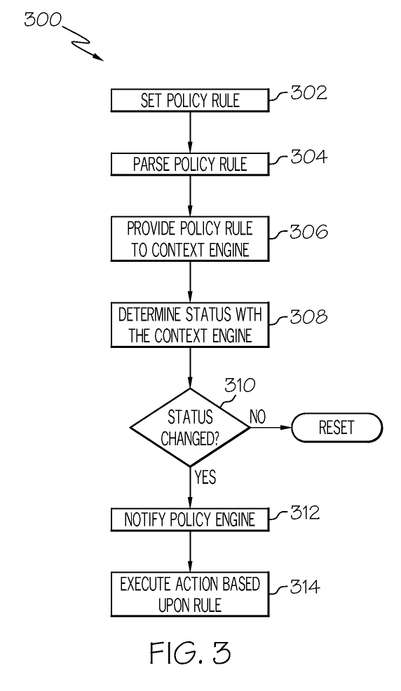

Referring now to FIG. 3, there is shown a flowchart 300 of an embodiment of a routine that may be used for the software environment 200. At block 302, a policy rule may be set by using one of the plurality of EIT applications 224 by an IT administrator, for example. At block 304, the policy rule may be parsed by the rule engine 220 of the policy engine 218. At block 306, the policy rule may be provided to the context engine 216. In one embodiment, a status-changing event may be registered with the context engine 216, allowing the context engine 216 to identify the status change of a condition in the computing device 100 such as disk health.

At block 308, the context engine 216 may determine that status of a condition. At block 310, a determination may be made as to if the status determined by the context engine 216 has changed. If the status has not changed, the routine may be reset for execution at a later time. If the status has changed, at block 312 the policy engine 312 is notified by of the status change. At block 314, an action may be executed based upon the policy rule previously set.

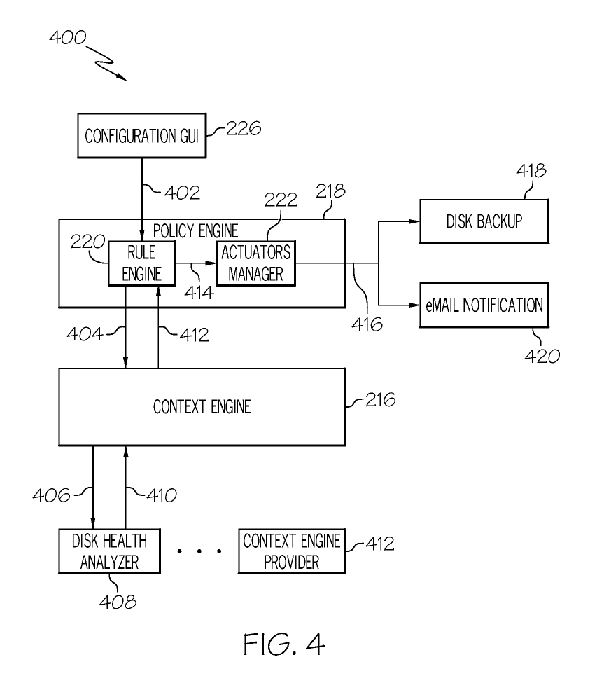

Referring now to FIG. 4, there is shown a block diagram illustrating an application of the flowchart 300 for predicted disk failure application of the software environment 200. In the embodiment of FIG. 4, the configuration GUI 226 may be used to set a policy for predicted disk failure in the rule engine 220 as indicated by arrow 402. The rule engine 220 may parse the policy rule and register the healthy status of a disk 206 with the context engine 216 as indicated by arrow 404. The context engine 216 may query a disk health analyzer 408 as indicated by arrow 406, which may be implemented through software from a context engine provider 412 operating on the computing device 100. The disk health analyzer 408 may return the disk health status to the context engine 216 as indicated by arrow 410. If the disk health status has changed, the context engine 216 may notify the rule engine 220 by an asynchronous event notification mechanism.

The disk health analyzer 408 may return the disk status to the context engine 216, as indicated by arrow 410. The rule engine 220 may invoke the actuators manager 222 to execute action of the rule as indicated by arrow. In one embodiment, the policy engine 218 may implement an Event-Condition-Action (ECA) style rule, which on an event occurring, if a condition is true, an action is performed. In the embodiment illustrated in FIG. 4, the policy engine 218 may implement the ECA-style rule, such that on the event that the status of the disk health has changed, and that the condition is an unhealthy disk (e.g., disk error), the actuators manager 222 may execute an action.

In FIG. 4, the actuators manager 22 may be configured to select a disk backup actuator 418 to execute a disk backup operation. The actuators manager 222 may be configured to select an e-mail notification actuator 420, which may provide an e-mail message to an IT administrator of the disk health status and the execution of the disk backup operation.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

What is claimed is:

1. A method, comprising:
setting a policy rule with an embedded information technology application,
parsing the policy rule from a policy engine to a context engine,
determining a computing device condition with the context engine based upon the parsed policy rule,
notifying the policy engine with the context engine if the computing device condition has changed from a first condition to a second condition, and
in response to the computing device condition changing from the first condition to the second condition, executing an action according to the parsed policy rule.

2. The method of claim 1, wherein the setting a policy rule further comprises setting a policy rule of an embedded information technology application with a configuration graphical user interface.

3. The method of claim 1, further comprising notifying the embedded information technology application that the computing device condition has changed from the first condition to the second condition.

4. The method of claim 1, further comprising parsing the policy rule with a rules engine of the policy engine.

5. The method of claim 1, wherein the providing the parsed policy rule from a policy engine comprises providing the parsed policy rule from a rules engine to a context engine, the parsed policy rule related to a computing device condition.

6. The method of claim 1, wherein the executing an action according to the policy rule comprises executing an action with an actuator provider manager.

7. A system comprising:
a computing device to operate a service operating system,
a policy engine operating on the service operating system, the policy engine to enforce a plurality of policy rules, wherein each of the plurality of policy rules is associated with one of the plurality of conditions of the computing device, and
a context engine operating on the service operating system, the context engine to receive notification to determine if a state change of at least one condition of the plurality of each condition of the computing device has occurred and to provide notification of the state change to the policy engine.

8. The system of claim 7, further comprising a configuration graphical user interface to provide the policy rules to the policy engine.

9. The system of claim 8, further comprising:
a virtual machine monitor to operate on the computing device, and
a virtual machine to operate on the virtual machine monitor,
wherein, the service operating system operates on the virtual machine.

10. The system of claim 7, wherein the policy engine comprises a rules engine to determine if an action is to be taken based upon the occurrence of the state change of the at least one of the plurality of computing device conditions.

11. The system of claim 10, wherein the policy engine further comprises an actuator provider manager to take the action if the state change of the at least one of the plurality of computing device conditions occurs.

12. The system of claim 10, further comprising an embedded information technology application to receive notification of the state change and of an action being taken.

13. The system of claim 7, wherein the computing device includes a vPro platform.

14. A machine readable medium comprising a plurality of instructions that in response to being executed, result in a computing device
providing a policy rule from a policy engine to a context engine,
determining the computing device condition with the context engine based upon the policy rule,
notifying an embedded information technology application with the context engine if the computing device condition has changed from a first condition to a second condition, and
in response to the computing device condition changing from the first condition to the second condition, executing an action according to the policy rule.

15. The method of claim 14 wherein the plurality of instructions further result in the computing device notifying the policy engine that the computing device condition has changed from the first condition to the second condition.

16. The method of claim 14, where the plurality of instructions further result in the computing device operating a service operating system on which a context engine operates.

17. The method of claim 14 wherein the plurality of instructions further result in the computing device parsing the policy rule with the policy engine, and
providing the parsed policy rule to the context engine.

18. The method of claim 17, wherein the plurality of instructions further result in the computing device parsing the policy rule with a rules engine of the policy engine.

19. The method of claim 17, wherein the plurality of instructions further result in the computing device providing the parsed policy rule from the rules engine to the context engine, the parsed policy rule related to a computing device condition.

20. The method of claim 17, wherein the plurality of instructions further result in the computing device executing an executing an action with actuator provider manager of the policy engine.
